(19) United States
(12) Patent Application Publication
(10) Pub. No.: US 2009/0191798 A1
(43) Pub. Date: Jul. 30, 2009

(54) INTEGRALLY MOLDED BRUSH AND THE METHOD OF MANUFACTURE AND ITS USES THEREOF

(76) Inventor: Siong Hong Koh, Singapore (SG)

Correspondence Address: 3M INNOVATIVE PROPERTIES COMPANY, PO BOX 33427, ST. PAUL, MN, 55133-3427, US

(21) Appl. No.: 12/160,458

(22) PCT Filed: Jan. 10, 2007
(86) PCT No.: PCT/US07/00598

§ 371 Date: Oct. 1, 2008

(30) Foreign Application Priority Data
Jan. 13, 2006 (SG) 200600224-0

(51) Int. Cl. B24B 1/00; A46B 1/00; B24D 3/28; B29D 31/00; B24B 29/00

(52) U.S. Cl. 451/59; 15/171; 51/298

(57) ABSTRACT

An aspect of the present invention comprises an integrally molded brush comprising a base and bristles extending from said base, further comprising a moldable composition that includes a dispersed phase comprising ultra-high molecular weight polyethylene. Another aspect of the present invention is a method of making an integrally molded brush comprising the steps of providing a moldable composition comprising a dispersed phase of ultra-high molecular weight polyethylene; causing said moldable composition to become a flowable material; shaping said flowable material; and hardening said flowable material. Other aspects of the present invention provides a method of refining a planar metal workpiece surface, the method comprising the steps of providing an integrally molded brush or brush assembly, each brush comprising a base and bristles extending from said base, further comprising a moldable composition that includes a dispersed phase comprising ultra-high molecular weight polyethylene, further comprising an attachment means; providing a driving means; providing a planar metal workpiece; coupling said integrally molded brush or brush assembly to said driving means via said attachment means; and rotating said brush or brush assembly while urging said rotating brush or brush assembly against said workpiece.

### FIELD

This disclosure is directed to an integrally molded brush or brush assembly and methods of making and using such a brush or brush assembly. Particularly, but not exclusively, it is directed to an abrasive brush or brush assembly.

### BACKGROUND

The use of abrasive brushes is common in many industries. Such brushes have applications, for example, in wood, metal, plastics and glass industries.

Taking the metal industries as an example, the processes of metal preparation, finishing and deburring commonly employ abrasive brushes to prepare or finish the surfaces. Appropriate brushes typically have a plurality of bristles that contact the surface. Such brushes have been provided with a variety of bristle types, materials and brush preparation methods.

Suitable bristle materials include polyesters, polyethylene, nylon and polypropylene. When abrasive brushes are required, these bristles are typically impregnated with abrasive particles. A mixture of abrasive particles and a thermoplastic binder may be combined and then extruded to form a bristle. The bristle is then cut to the desired length.

One of the steps in the manufacture of brushes of this type is the mechanical combination and mounting of the bristle materials on a central support, roller or wheel or the like to form a brush. The bristles are usually inserted into the support in the form of individual tufts or placed in bundles.

An alternative form of brush manufacture is using the injection molded brush technology described in U.S. Pat. No. 5,903,951. Such brushes have a plurality of bristles extending radially from and integrally molded with a central portion (hub). A plurality of these brushes can be combined (e.g., ganged on a central shaft) to form a brush assembly.

In some embodiments, these injection-molded brushes comprise a thermoplastic elastomer.

Compared to thermoplastic elastomers, polyamide (e.g., nylon 6 or nylon 6,6) is cheaper. However, brushes prepared by injection molding of nylon are too brittle for many abrasive brush applications, particularly where the surface to be worked is metal.

### SUMMARY OF THE INVENTION

The present invention is directed to an integrally molded brush comprising a base and bristles extending from said base, further comprising a moldable composition that includes a dispersed phase comprising ultra-high molecular weight polyethylene. In some embodiments, the integrally molded brush further includes abrasive particles. In some embodiments, the moldable composition is thermoplastic. In some embodiments, the moldable composition comprises a thermoplastic elastomer. In some embodiments, the moldable composition comprises a polyamide. In some embodiments, the integrally molded brush is a radial brush.

In another aspect, the present invention provides a brush assembly comprising a plurality of integrally molded brushes further comprising a moldable composition that includes a dispersed phase of ultra-high molecular weight polyethylene.

In another aspect, the present invention provides a method of making an integrally molded brush comprising a base and bristles extending from said base, further comprising a moldable composition that includes a dispersed phase comprising ultra-high molecular weight polyethylene. In some embodiments, the method comprises the steps of:
a. providing a moldable composition comprising a dispersed phase of ultra-high molecular weight polyethylene;
b. causing said moldable composition to become a flowable material;
c. shaping said flowable material; and
d. hardening said flowable material.

In some embodiments, the method of making includes an additional step:
e. annealing at least said bristles of said integrally molded brush.

In some embodiments, said moldable composition is thermoplastic. In some embodiments, said moldable composition is a thermoplastic elastomer. In some embodiments, said moldable composition is made flowable by heating. In some embodiments, said flowable composition is shaped by molding. In some embodiments, said flowable composition is shaped by injection molding.

In another aspect, the present invention provides a method of refining a planar metal workpiece surface, the method comprising the steps of:
a. providing an integrally molded brush or brush assembly, each brush comprising a base and bristles extending from said base, further comprising; a moldable composition that includes a dispersed phase comprising ultra-high molecular weight polyethylene, further comprising an attachment means;
b. providing a driving means;
c. providing a planar metal workpiece;
d. coupling said integrally molded brush or brush assembly to said driving means via said attachment means; and
e. rotating said brush or brush assembly while urging said rotating brush or brush assembly against said workpiece.

In some embodiments, the planar metal workpiece is a mild steel sheet bearing a passivating coating.

In another aspect, the present invention provides a method of making an integrally molded brush comprising a base and bristles, further comprising the steps of:
a. providing a moldable composition comprising a dispersed phase of ultra-high molecular weight polyethylene;
b. injection molding said moldable composition to form an integrally molded brush; and
c. annealing at least said bristles of said integrally molded brush.

As used herein:

the phrase “integrally molded brush” means a brush having a base or hub and bristles extending from that base or hub, wherein the bristles and at least a portion of the base or hub are formed together;
the phrase “dispersed phase” means that the material of the described phase exists as a plurality of domains heterogeneous from and dispersed within a continuous matrix composition;
the word “refine” means a process including at least one of the following: removal of a portion of a workpiece surface; imparting a surface finish to a workpiece; descaling a surface; deburring a surface; cleaning a workpiece surface, including removing paint or other coatings, gasket material, corrosion, oil residue, or other foreign material or debris; or some combination of the foregoing; and
the word “workpiece” means any suitable substrate or surface including metal, wooden or otherwise, which would benefit from finishing, descaling, cleaning, —polishing or deburring for example.

### BRIEF DESCRIPTION OF THE DRAWINGS

The present invention will be further explained with reference to the appended figures, wherein like structure is referred to by like numerals throughout the several views, and wherein:

FIG. 1 is a plan view of part of a brush of the present invention but wherein the tips of the bristles of the brush are not shown,

FIG. 2 is a side view of FIG. 1,

FIG. 3 is a sectional view of section BB of FIG. 1,

FIG. 4 is a plan view of an alternative form of a brush of the present invention,

FIG. 5 is a perspective view of a brush assembly incorporating a plurality of brushes as herein described,

FIG. 6 is a photograph of the result as herein described with reference to Example 1, and

FIG. 7 is a photograph of the result as herein described with reference to Example 1.

### DETAILED DESCRIPTION

### Integrally Molded Brush

The integrally molded brush of the present invention comprises a base (or hub) from which a plurality of bristles protrudes. The base and the bristles are unitary. The integrally molded brush is made from a moldable composition matrix that contains a dispersed phase of ultra-high molecular weight polyethylene.

The integrally molded brush may be a radial brush wherein the bristles protrude radially from the periphery of the base and generally coplanar with the base. Such brushes are variously known as radial brushes, cylinder brushes, or wheel brushes. Alternatively, the integrally molded brush may have bristles extending generally perpendicularly from at least one side of the base. Such brushes are variously known as cup bushes or right angle brushes.

While the base or hub of the inventive brush is generally planar, it may be cup-shaped or otherwise deformed out-of-plane. The base or hub may contain projections, openings, or depressions that serve, for example, to interlock adjacent brushes together for driving purposes. The base or hub may have an attachment provision, for example, for coupling to a power tool. Such attachment provisions include arbors, openings for receiving arbors, threaded studs, various quick-release fasteners, and the like. The base is generally circular but may be of any shape. The base may be of any size.

The integrally molded brushes of the invention also include bristles integral to the base or hub. These bristles may be disposed coplanar to the base, perpendicular to the base, or any intermediate orientation with respect to the base. The bristles may be of any length and diameter, but in some embodiments, the ratio of bristle length to bristle diameter is 2:1 or greater.

Bristles may have any cross sectional area, including but not limited to, circular, star, half moon, quarter moon, oval, teardrop, rectangular, square, triangular, diamond, or other polygonal shape. In one embodiment, bristles comprise a constant cross section along the length of bristle. In other embodiments, bristles will have a non-constant or variable cross section along the length of the bristle.

Bristles may be tapered such that the cross sectional area of the bristle decreases in the direction away from root (adjacent the base) towards tip (distal from the base). Tapered bristles can have any cross section as described above. Bristles are subjected to bending stresses as the brush segment is rotated against a workpiece. These bending stresses are highest the root of bristles. Therefore, a tapered bristle is more able to resist bending stresses than a bristle of constant cross sectional area. Bristles can have a taper along the entire length, or can have a tapered portion adjacent the root and a constant cross sectional area for the remainder of the bristle. The taper can comprise any suitable angle or combination of angles.

The density and arrangement of bristles can be chosen for the particular application of the brush. In some embodiments, bristles are arranged uniformly around the outer edge of the base or hub. Alternatively, bristles can be arranged in groups with spaces between the groups, and can be oriented in the plane of the base other than radially outward, that is, at a non-zero angle relative to the radius of the base. Radial brushes of the invention may have multiple rows of bristles extending from the periphery of the base.

### Moldable Composition

In some embodiments, the moldable composition is polymeric. In some embodiments, the moldable composition may be thermoplastic.

Examples of suitable thermoplastic polymers include polycarbonate, polyetherimide, polyester, polyethylene, polysulfone, polystyrene, polybutylene, acrylonitrile-butadiene-styrene block copolymer, polypropylene, acetal polymers, polyurethanes, polyamides, and combinations thereof. In general, preferred thermoplastic polymers of the invention are those having a high melting temperature and good heat resistance properties.

Examples of commercially available thermoplastic polymers suitable for use with the present invention include GRILON CR9 copolymer of nylon 6,12 available from EMS-American Grilon, Inc., Sumter, S.C.; Profaxm and KS075 polypropylene based thermoplastic available from Himont USA, Inc., Wilmington, Del.; DURAFLEX polybutylene based thermoplastic available from Shell Chemical Co., Houston, Tex., and HYTREL a thermoplastic polyester elastomer available from Du Pont.

One particular thermoplastic polymer suitable for use with the present invention is a polyamide resin material, which is characterized by having an amide group, i.e. —C(O)NH—.

Various types of polyamide resin materials (i.e., nylon) can be used, such as nylon 6,6 or nylon 6. Nylon 6,6 is a condensation product of adipic acid and hexamethylenediamine. Nylon 6,6 has a melting point of about 264° Celsius (° C.) and a tensile strength of about 770 kg/cm². Nylon 6 is a polymer of 8-caprolactam. Nylon 6 has a melting point of about 220° C. and a tensile strength of about 700 kg/cm². Examples of commercially available nylon resins useable as moldable compositions in articles according to the present invention include “VYDYNE” from Monsanto, St. Louis, Mo. “ZYTEL” and “MINION” both from Du Pont, Wilmington, Del. “TROGAMID” from Huls America, Inc., Piscataway, N.J. “CAPRON” from Allied Chemical Corp., Morristown, N.J. “NYDUR” from Mobay, Inc., Pittsburgh, Pa. and “ULTRAMID” from BASF Corp., Parsippany, N.J.

### Ultra-High Molecular Weight Polyethylene

Ultra-high molecular weight polyethylene is dispersed within the moldable composition.

Ultra-high molecular weight polyethylene is an essential component of the molded brush of the present invention. It is incorporated into the moldable composition in an amount of between 1% and 20%, or in an amount between 2% and 15%, or even in an amount between 4% and 6%, based on the weight of the moldable composition.

For the purposes of this invention, ultra-high molecular weight polyethylene is polyethylene having a molecular weight of at least one million. Preferably, the ultra-high molecular weight polyethylene of the present invention has a molecular weight of at least two million.

Ultra-high molecular weight polyethylene is incorporated as a powder of particle size less than 200 micrometers, sometimes less than 100 micrometers, and sometimes even less than 50 micrometers. In one embodiment, the ultra-high molecular weight polyethylene is incorporated as a powder of particle size of 25 micrometers to 30 micrometers.

Suitable ultra-high molecular weight polyethylene is available, for example, from Mitsui Chemicals America, Inc., Purchase, N.Y. under the trade designation “MIPELON”, or from Ticona North America, Florence, Ky., under the trade designation “GUR”.

### Abrasive Particles

In some embodiments, the integrally molded brush of the present invention includes abrasive particles. In some embodiments, the abrasive particles are dispersed within at least the bristles of the brush. In some embodiments, the abrasive particles are adhered to at least a portion of the bristles, optionally with an adhesive coating applied to at least a portion of the bristles.

Useful abrasive particles may be inorganic or organic, individual or agglomerated, hard or soft, and of any size or grade. Various combinations of abrasive particle composition, hardness, and size are also useful in some embodiments. Appropriate selections of abrasive particles are routinely made by one of ordinary skill.

Useful abrasive particle compositions include, for example, aluminum oxide, ceramic aluminum oxide, silicon carbide, heat treated aluminum oxide, glass, diamond, nut shells, particulate phenolic resin, particulate melamine resin, particulate poly(vinyl chloride), and particulate polycarbonate.

Useful abrasive particle sizes are typically from about 0.1 micrometer to 1500 micrometers, in some embodiments between about 1 micrometer to 1000 micrometers, and in other embodiments between 50 micrometers and 500 micrometers.

When included in the integrally molded brush of the present invention, abrasive particles may be present in an amount from 0.1% to 300% based on the weight of the moldable composition, in some embodiments from 1% to 150% based on the weight of the moldable composition, or in other embodiments 5% to 100% based on the weight of the moldable composition.

### Brush Assembly

For the purposes of this invention, a brush assembly is a plurality of brushes aggregated for use as a single unit. Typically, a brush assembly is aggregated such that a common driving means may be employed. In some embodiments the brush assembly of the invention is an aggregation of radial brushes.

In some embodiments, radial brush assemblies are aggregated from brushes such that the base of each brush is parallel to an adjacent brush. In some embodiments, the base of each brush in the brush assembly is in contact with the base of at least one other brush. In some embodiments, each brush of a brush assembly is interlocked with at least one adjacent brush to provide for common rotation.

Brushes of a brush assembly may have the same or different diameters, bristle patterns, bristle lengths, bristle shapes, and/or compositions.

### Method of Making an Integrally Molded Brush

The integrally molded brush of the present invention is conveniently manufactured by a method comprising the steps of:
1. providing a moldable composition comprising a dispersed phase of ultra-high molecular weight polyethylene;
2. causing said moldable composition to become a flowable material;
3. shaping said flowable material; and
4. hardening said flowable material.

In some embodiments the method of making includes an additional step:
5. annealing at least said bristles of said integrally molded brush.

The moldable composition comprising a dispersed phase of ultra-high molecular weight polyethylene has been described in detail, supra. Conveniently, the dispersed phase of ultra-high molecular weight polyethylene is provided by incorporating ultra-high molecular weight polyethylene in the form of a powder into the moldable composition. In useful embodiments, the moldable composition is thermoplastic.

The moldable composition is then rendered flowable. Frequently, especially with a thermoplastic moldable composition, this is accomplished by heating, typically in an extruder, injection molding apparatus, or heated press.

The flowable material is then shaped using any of several means. In a useful embodiment, the material is shaped by injecting the flowable composition into a brush-shaped cavity under pressure. Alternatively, the flowable material may be shaped by extrusion through a film die to form a sheet.

The shaped, flowable material is then hardened. When the flowable material is a thermoplastic, hardening is conveniently accomplished by cooling, In the case of injection molding, the hardened brush shape is then removed from the mold cavity.

In the event that the flowable material was shaped into a sheet, brush shapes may be cut from the sheet by any known means.

In some embodiments, at least the bristles of the brushes formed in this process are annealed to relieve residual stresses and to result in longer-lived brushes. Annealing is conveniently accomplished by thermal means. An effective annealing process is accomplished by immersing at least the bristles of a brush in boiling water for at least 30 seconds, in some embodiments at least one minute, or in some embodiments at least five minutes. The annealed brush is then cooled, whereby it is ready for use.

### Method of Using an Integrally Molded Brush

Brushes and/or brush assemblies according to the present invention are efficacious when employed to abrade, polish, clean, or otherwise modify the surface of a workpiece. The present invention provides a method of refining a workpiece surface, the method comprising the steps of:
1. providing an integrally molded brush or brush assembly, each brush comprising a base and bristles extending from said base, further comprising a moldable composition that includes a dispersed phase comprising ultra-high molecular weight polyethylene, further comprising an attachment means;
2. providing a driving means;
3. providing a workpiece;
4. coupling said integrally molded brush or brush assembly to said driving means via said attachment means; and
5. imparting motion to said brush or brush assembly while urging said brush or brush assembly against said workpiece.

For the method of using the integrally molded brush or brush assembly of the present invention, the brush or brush assembly according to the description, supra, is provided. A useful embodiment is a brush assembly of a plurality of radial integrally molded brushes. Frequently, the brush assembly is of a sufficient number of radial brushes to achieve a brush assembly width equal to or greater than the width of the workpiece. A means of attaching the brush or brush assembly to a driving means is included. Such an attachment means may be conveniently be a centrally-disposed shaft.

The driving means may be of any type. It may be a manual means or an automated driving means. Frequently the driving means imparts rotation. A particularly useful driving means is a motor driven shaft.

The workpiece may be any with at least one surface to be abraded, polished, cleaned, or otherwise modified. In some embodiments, the workpiece surface is substantially planar. In some embodiments, the workpiece surface is a planar metal surface. A particularly applicable workpiece is mild steel in sheet or coil (roll) form, particularly when the mild steel sheet or coil has a coating requiring removal.

Any convenient method of coupling the inventive brush or brush assembly to the driving means may be used. In some embodiments, the coupling means may be via a belt or chain.

The brush is now driven and urged against the workpiece, whereby the workpiece surface is suitably modified.

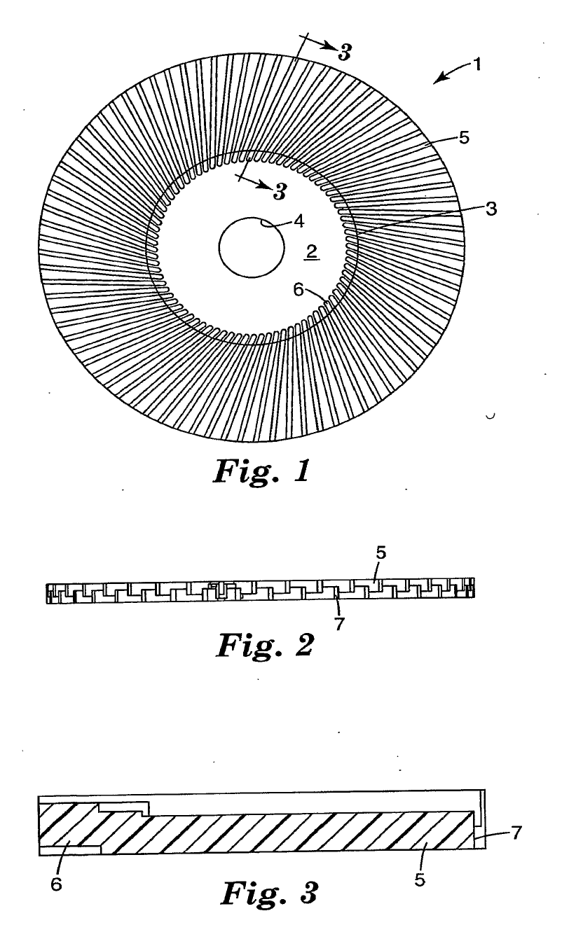

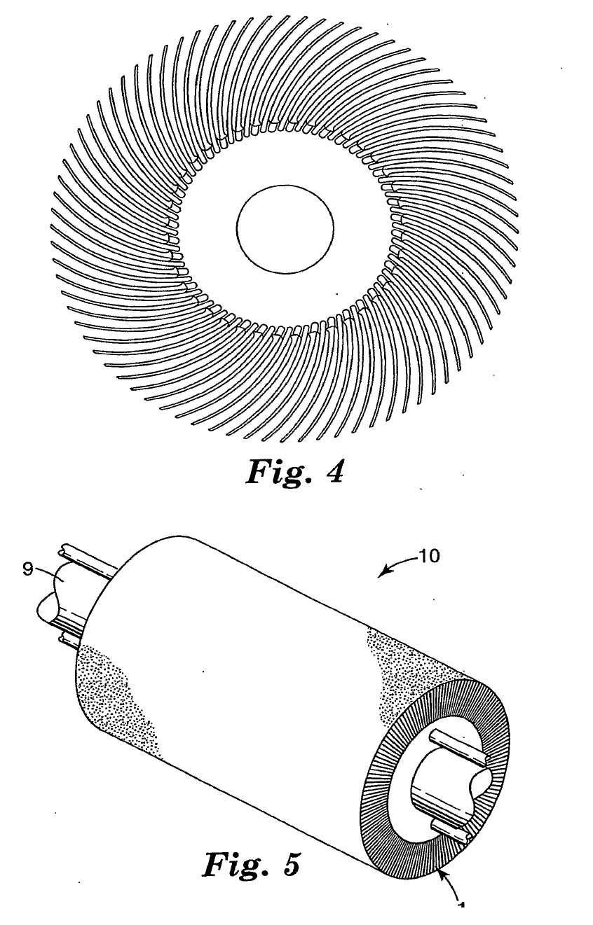

Referring now to FIGS. 1 through 3, a preferred form of an abrasive brush 1 is described having a base 2 having outer edge 3 and inner edge 4. A plurality of bristles 5 project outwardly from the outer edge, beginning at bristle roots 6 and ending at bristle tips 7. There may be spaces between bristle roots in which the outer edge 3 of the base 2 is exposed. Alternatively, adjacent bristles may adjoin one another at roots. The brush 1 is integrally molded such that bristles 5 and the base 2 are continuous with one another; that is, there is no material breach between the base 2 and bristles 5. In one preferred embodiment, the brush 1 is an abrasive brush that comprises a generally homogenous composition of abrasive particles in a moldable or molded polymer.

As illustrated in FIG. 5, a plurality of brushes 1 can be assembled onto a shaft 9 to form a brush assembly 10. Any number of brushes 1 may be assembled together to provide an assembly of any desired width. Preferably, the brushes 1 are adjacent one another such that there is essentially no space between the brushes 1, although alternatively, segments may be assembled onto a shaft so as to have space between adjacent brushes 1. There may be 5 to 10,000 brush segments assembled together to form an assembly 10, although more or less may be used as desired. A means for providing brush-to-brush engagement may be included to reduce or eliminate rotation of adjacent brushes relative to one another. Such engagement means can include, for example, an interengaging hole and dimple pattern on the surfaces of base or, alternatively, radially disposed keyways. Alternatively, the bristles may project axially further beyond the radial surfaces of the base 2 as for example, shown in FIGS. 2 and 3. Such axial offset of the bristles is in an alternating fashion as for example shown in FIG. 2. While each alternate bristle is in partial overlap with an adjacent bristle in the axial direction, the offset is ultimate in regards to immediately adjacent bristles in opposing axial directions of the brush. This allows for a nesting of the bristles of adjacent brushes to occur. Such nesting can provide a way of eliminating rotation of adjacent brushes relative to each other.

### EXAMPLES

### Example 1

An integrally molded brush was prepared from a composition consisting of 72% nylon 6 (“AMILAN CM1017”, obtained from Toray Industries, Tokyo, Japan), 24% P grade 80 aluminum oxide abrasive particles (“ALODUR BFRPL”, obtained from Treibacher Schleifmittel, Treibach, Austria), and 4% ultra-high molecular weight polyethylene powder (“MIPELON XM-220”, obtained from Mitsui Chemicals, Tokyo, Japan).

This composition was injection molded (“J120 SA II” from JSW Company, 120 ton machine, barren temperature 280° C., mold temperature 25° C., injection pressure of 67.5 kg/cm²) and then annealed by immersing each brush in boiling water at 100° C. for 5 minutes. A radial brush assembly was constructed by ganging up 75 brushes of 4 mm thickness to form a 300 mm wide brush assembly.

### Comparative Example A

An integrally molded brush was prepared as described in Example 1 from a composition consisting of 60% thermoplastic elastomer (HYTREL, DuPont Company, Wilmington, Del.), 10% lubricant (silicone gum, “MB-50-010”, Dow Corning Corporation, Midland, Mich.), and 30% P-grade 80 aluminum oxide abrasive particles (“ALODUR BFRPL”, obtained from Treibacher Schleifmittel, Treibach, Austria).

### Comparative Example B

This comparative brush was a conventional 100 mm outer diameter (o.d.), 25 mm inner diameter (i.d.), 300 mm wide channel brush with 1.27 mm (50 mil) diameter “TYNEX” (DuPont Company, Wilmington, Del.) bristles containing ANSI grade 80 aluminum oxide.

The brush assemblies of Example 1 and Comparative Examples A & B were evaluated using a “Burry Tack EX II (III-CT-600)” (Toban Industry, Tokyo, Japan) wide-brush machine. The workpiece to be modified was a mild steel panel having a chromate coating. Brush assemblies for evaluation were mounted onto a central shaft prior to installation on the wide-brush machine.

Operating conditions were:

| | |
|---|---|
| Brush | 1800 revolutions per minute (rpm) |
| speed | |
| Conveyor | 3 meters per minute |
| speed | |
| Brush | the interference was adjusted to a distance |
| height | to allow only the bristle tips to encounter |
| | the workpiece surface. |

The comparative performance was determined by the number of passes required for complete removal of the chromate coating from the mild steel substrate.

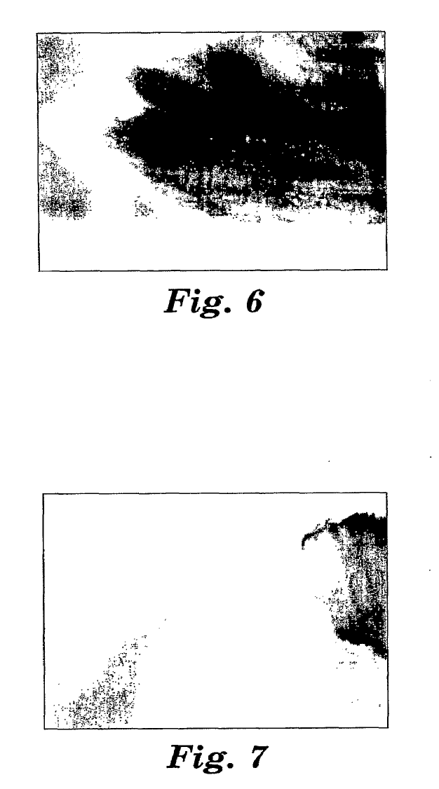

Example 1 removed the chromate coating from the metal substrate in three passes, whereas Comparative Examples A & B could not remove the coating, even after five passes. The results are shown in the photographs of FIGS. 6 and 7.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. For example, the molded brush segment according to the present invention may be provided with means for introducing fluid such as coolants, lubricants, and cleaning fluids to the workpiece during operation as is known in the art, such as by openings through the backing or bristles. Thus, the scope of the present invention should not be limited to the exact details and structures described herein, but rather by the structures described by the language of the claims, and the equivalents of those structures.

What is claimed is:

1. An integrally molded brush comprising a base and bristles, further comprising a moldable composition, wherein said moldable composition includes a dispersed phase of ultra-high molecular weight polyethylene.

2. The integrally molded brush of claim 1 further comprising abrasive particles.

3. The integrally molded brush of claim 1 wherein said moldable composition is thermoplastic.

4. The integrally molded brush of claim 1 wherein said moldable composition comprises a polyamide.

5. The integrally molded brush of claim 1 wherein 1% to 20% by weight of the moldable composition comprises ultra-high molecular weight polyethylene.

6. A brush assembly comprising a plurality of integrally molded brushes comprising a base and bristles, each of said brushes comprising a moldable composition, said moldable composition including a dispersed phase of ultra-high molecular weight polyethylene.

7. The brush assembly of claim 6 wherein said integrally molded brushes are radial brushes.

8. A method of making an integrally molded brush comprising a base and bristles, further comprising the steps of:
a. providing a moldable composition comprising a dispersed phase of ultra-high molecular weight polyethylene;
b. causing the said moldable composition to become a flowable material;
c. shaping said flowable material; and
d. hardening said shaped flowable material.

9. The method of claim 8 comprising a further step of:
e. annealing at least said bristles of said brush.

10. A method of brushing a surface comprising the steps of:
a. providing an integrally molded brush comprising a base and bristles further comprising a moldable composition including a dispersed phase of ultra-high molecular weight polyethylene;
b. providing a workpiece having at least one surface to be modified;
c. providing a driving means;
d. coupling said integrally molded brush to said driving means; and
e. driving said integrally molded brush while urging said integrally molded brush against said workpiece;
whereby said at least one surface is effectively modified.

11. The method of claim 10 wherein said workpiece is a planar metal workpiece.

12. A method of making an integrally molded brush comprising a base and bristles, further comprising the steps of:
a. providing a moldable composition comprising a dispersed phase of ultra-high molecular weight polyethylene;
b. injection molding said moldable composition to form an integrally molded brush; and
c. annealing at least said bristles of said integrally molded brush.
